(19) United States
(12) Patent Application Publication
(10) Pub. No.: US 2019/0041025 A1
(43) Pub. Date: Feb. 7, 2019

(54) AUTOMOTIVE LAMP

(71) Applicant: KOITO MANUFACTURING CO., LTD., Tokyo (JP)

(72) Inventor: Takashi INOUE, Shizuoka (JP)

(73) Assignee: KOITO MANUFACTURING CO., LTD., Tokyo (JP)

(21) Appl. No.: 16/049,271

(22) Filed: Jul. 30, 2018

(30) Foreign Application Priority Data
Aug. 7, 2017 (JP) 2017-152584
Jan. 11, 2018 (JP) 2018-022791

(51) Int. Cl. F21S 45/48; F21V 29/51

(52) U.S. Cl. CPC F21S 45/48; F21Y 2115/10; F21V 29/51

(57) ABSTRACT

In an automotive lamp, a lamp unit is housed in a lamp chamber, an LED being used as a light source of the lamp unit, and the lamp chamber including an outer lens and a lamp body. The automotive lamp includes a heat sink including a plurality of heat dissipating fins and mounted to the lamp body such that the heat dissipating fins are exposed outside the lamp chamber; an LED support member that supports the LED and that is tiltably supported relative to the heat sink; and a spirally-shaped heat pipe connecting the LED support member and the heat sink.

### BACKGROUND OF THE INVENTION

### 1. Field of the Invention

The present invention relates to an automotive lamp, and more particularly, to an automotive lamp in which a semiconductor light emitting device is used as a light source.

### Background Art

Automotive lamps in which a semiconductor light emitting device such as a light emitting diode (LED) as a light source are known in the related art. Where a semiconductor light emitting device is used as a light source of an automotive lamp, the light amount level required for an automotive lamp need be met by maximally exploiting the light emission of the semiconductor light emitting device.

Generally, the heat generated by a semiconductor light emitting device increases when a large current is supplied to obtain a high output. When the temperature of the device becomes high due to the heat generation, the light emitting efficiency drops. In this background, a variety of heat dissipating structures of an automotive lamp are proposed in order to dissipate the heat from the semiconductor light emitting device efficiently.

For example, a heat dissipating structure is proposed in which a support member for a semiconductor light emitting device and a heat sink exposed outside a lamp chamber comprised of an outer lens and a lamp body are connected to each other by a heat pipe (see, for example, patent document 1).

[patent document 1] JP2004-311224

In the above-described heat dissipating structure in which a heat pipe is used, the heat generated from the semiconductor light emitting device can be efficiently dissipated outside the lamp chamber via the heat pipe. However, when the lamp unit is tilted for aiming control, the heat pipe may inhibit the movement of the lamp unit and may make it difficult to perform aiming control suitably.

### SUMMARY OF THE INVENTION

In this background, a purpose of the present invention is to provide an automotive lamp capable of dissipating the heat generated from the semiconductor light emitting device outside the lamp chamber efficiently and allowing aiming control to be performed suitably.

In an automotive lamp according to one embodiment of the present invention, a lamp unit is housed in a lamp chamber, a semiconductor light emitting device being used as a light source of the lamp unit, and the lamp chamber including an outer lens and a lamp body. The automotive lamp comprises: a heat sink mounted to the lamp body such that a part of the heat sink is exposed outside the lamp chamber; a light source support member that supports the semiconductor light emitting device and that is tiltably supported relative to the heat sink; and a spirally-shaped heat pipe connecting the light source support member and the heat sink.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a schematic cross section of an automotive lamp according to an embodiment of the present invention;

FIG. 2 is a perspective view of the lamp unit and the heat sink viewed from a point diagonally in front;

FIG. 3 is a perspective view of the lamp unit and the heat sink viewed from a point diagonally behind;

FIG. 4 is a schematic front view showing that a heat transfer unit is mounted to the heat sink;

FIG. 5 shows conditions of dimensions of the heat receiving plate and the heat dissipating plate; and

FIG. 6 shows a schematic cross section of an automotive lamp according to another embodiment of the present invention.

### DETAILED DESCRIPTION OF THE INVENTION

The invention will now be described by reference to the preferred embodiments. This does not intend to limit the scope of the present invention, but to exemplify the invention.

A detailed description will now be given of an automotive lamp according to an embodiment of the present invention with reference to the drawings. Where a term indicating a direction such as “top”, “bottom”, “front”, “rear”, “left”, “right”, “interior”, and “outside” is used in the specification, the term signifies a direction defined when the automotive lamp is mounted in its position on a vehicle.

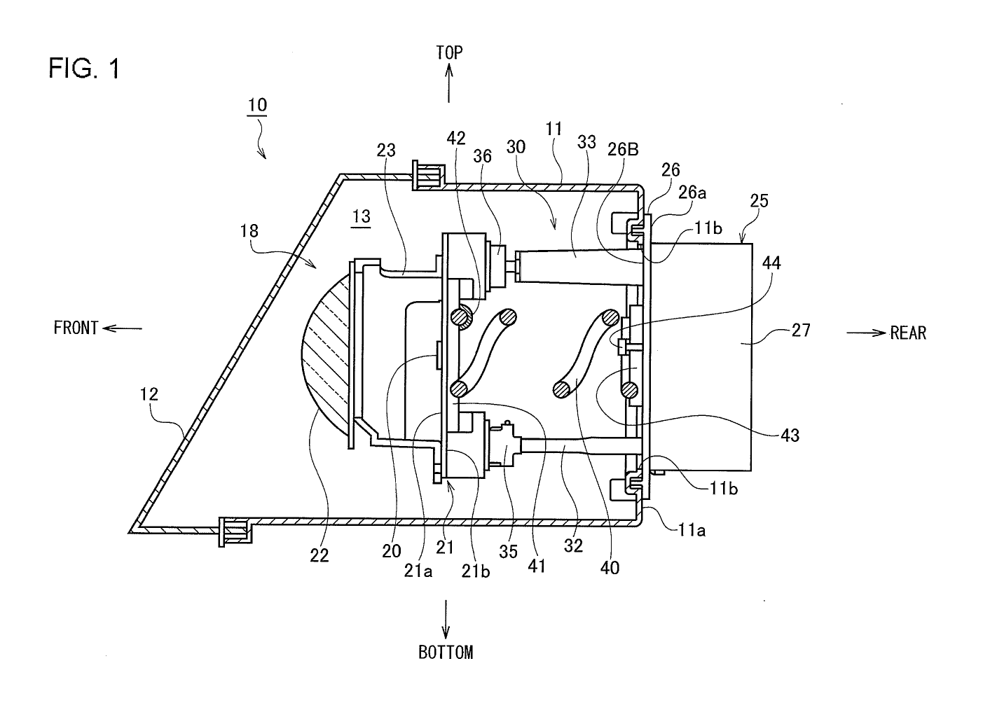

FIG. 1 shows a schematic cross section of an automotive lamp 10 according to an embodiment of the present invention. As shown in FIG. 1, the automotive lamp 10 is configured such that a lamp unit 18 in which a semiconductor light emitting device is used as a light source is housed in a lamp chamber 13, the lamp chamber 13 including a resin lamp body 11 with an open front and an outer lens 12 made of a translucent material and hermetically covering the front of the lamp body 11.

The lamp unit 18 is provided with an LED 20 as a light source, an LED support member 21 for supporting the LED 20, a projection lens 22 for controlling light emitted from the LED 20, and a lens support 23 for supporting the projection lens 22 in front of the LED 20 (direction of irradiation). The lamp unit 18 is of a so-called direct incidence type in which the direct light from the LED 20 mounted to a front face 21a of the LED support member 21 is projected by the projection lens. The lamp unit 18 may not be of a direct incidence type. For example, the lamp unit may be of a projector type in which the light from the LED is reflected by a reflector and the projected light is projected by the projection lens.

The automotive lamp is further provided with a heat sink for dissipating the heat generated from the LED 20 outside the lamp chamber 13. The heat sink 25 is made of a metal having a high coefficient of thermal conductivity such as aluminum and is comprised of a base 26 of a flat plate shape and a plurality of heat dissipating fins 27 of a flat plate shape provided to stand at predetermined intervals on a rear face 26a of the base 26. The shape of the heat dissipating fins 27 is not limited to a flat plate shape. The heat dissipating fins 27 may be columnar fins.

As shown in FIG. 1, the heat sink 25 is mounted to the lamp body 11 such that the plurality of heat dissipating fins 27 constituting the heat sink 25 are exposed outside the lamp chamber 13. An opening 11b is provided on a rear face 11a of the lamp body 11. The heat sink 25 is mounted to the rear face 11a of the lamp body 11 such that the base 26 hermetically covers the opening 11b.

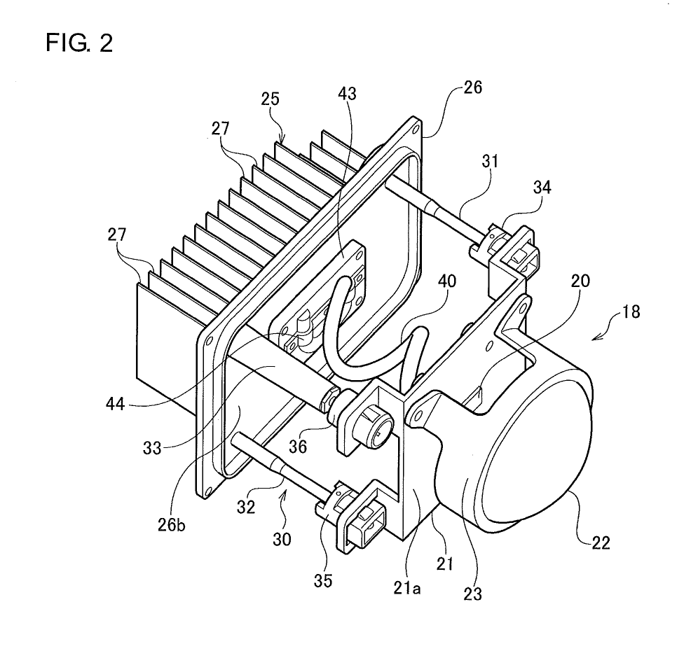

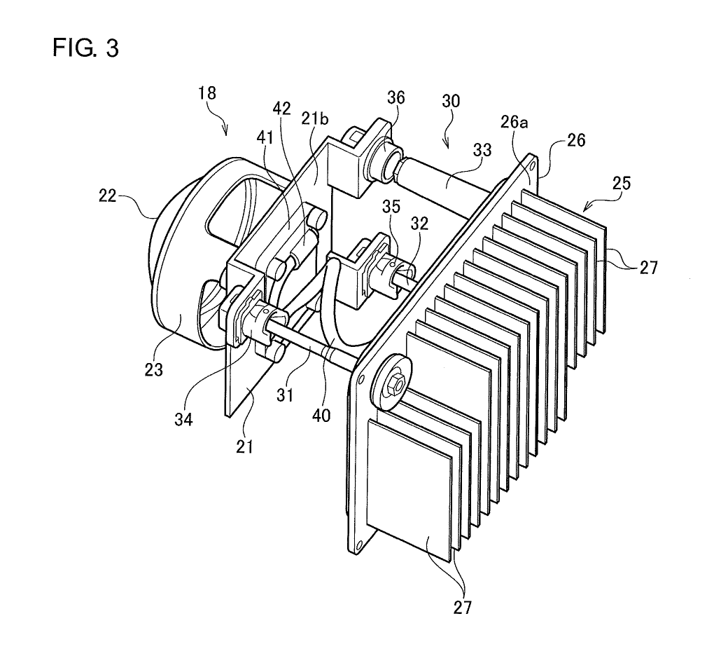

FIG. 2 is a perspective view of the lamp unit 18 and the heat sink 25 viewed from a point diagonally in front. FIG. 3 is a perspective view of the lamp unit 18 and the heat sink 25 viewed from a point diagonally behind. As shown in FIGS. 1 through 3, the lamp unit 18 is supported by an aiming mechanism 30 so as to be tiltable in the vertical direction and the horizontal direction relative to the heat sink 25.

The aiming mechanism 30 is provided with a first aiming screw 31, a second aiming screw 32, and a support rod 33 that extend from a front face 26b of the base 26 of the heat sink 25 to the LED support member 21. The base end of the first aiming screw 31 is rotatably supported by the top right part of the base 26 of the heat sink 25, when viewed from the front of the lamp. The distal end of the first aiming screw 31 is threadably engaged with a first aiming nut 34 provided in the top right part of the LED support member 21, when viewed from the font of the lamp. The base end of the second aiming screw 32 is rotatably supported by the bottom left part of the base 26 of the heat sink 25, when viewed from the front of the lamp. The distal end of the second aiming screw 32 is threadably engaged with a second aiming nut 35 provided in the bottom left part of the LED support member 21, when viewed from the front of the lamp. The base end of the support rod 33 is supported by the top left part of the base 26 of the heat sink 25, when viewed from the front of the lamp. The distal end of the support rod 33 is fitted to a ball joint 36 provided in the top left part of the LED support member 21, when viewed from the front of the lamp.

When the first aiming screw 31 is rotated, the LED support member 21 is tilted in the horizontal direction around the ball joint 36. When the second aiming screw 32 is rotated, the LED support member 21 is tilted in the vertical direction around the ball joint 36. By tilting the LED support member 21 vertically and horizontally relative to the heat sink 25 by using the aiming mechanism 30, aiming control (light axis control) of the lamp unit 18 can be performed.

As shown in FIGS. 1 through 3, the LED support member 21, on which the LED 20 is mounted, and the heat sink 25 are spaced apart from each other in the automotive lamp 10 according to the embodiment. To conduct the heat generated from the LED 20 to the heat sink 25, the automotive lamp 10 is provided with a spirally-shaped heat pipe 40 that connects the LED support member 21 and the heat sink 25.

A heat receiving plate 41 for transferring the heat generated from the LED 20 to the heat pipe 40 is fixed on a rear face 21b of the LED support member 21. The heat receiving plate 41 is a plate-like body made of an aluminum alloy or copper having a high coefficient of thermal conductivity. The surface of the heat receiving plate 41 may be plated with nickel. The end of the heat pipe 40 toward the LED support member is connected to the heat receiving plate 41 using a method such as soldering characterized by small heat transfer loss. In order to ensure that the heat pipe 40 is properly connected to the heat receiving plate 41, a metal fixing member 42 formed in a semi-cylindrical shape may be used. Grease may fill the area between the heat pipe 40 and the heat receiving plate 41 to promote heat transfer.

A heat dissipating plate 43 for transferring the heat from the heat pipe 40 to the heat sink 25 is provided on the front face 26b of the base 26 of the heat sink 25. The heat dissipating plate 43 is a plate-like body made of an aluminum alloy or copper having a high coefficient of thermal conductivity. The surface of the heat dissipating plate 43 may be plated with nickel. The end of the heat pipe 40 toward the heat sink is connected to the heat dissipating plate 43 using a method such as soldering characterized by small heat transfer loss. In order to ensure that the heat pipe 40 is properly connected to the heat dissipating plate 43, a metal fixing member 44 formed in a semi-cylindrical shape may be used. Grease may fill the area between the heat pipe 40 and the heat dissipating plate 43 to promote heat transfer.

In the automotive lamp 10 according to the embodiment having the above-described configuration, the heat generated from the LED 20 is transferred to the heat pipe 40 via the LED support member 21 and the heat receiving plate 41. The heat transferred through the heat pipe 40 is transferred to the heat sink 25 via the heat dissipating plate 43 and dissipated to an external space from the heat dissipating fins 27 exposed outside the lamp chamber 13. In this way, the temperature of the LED 20 is inhibited from increasing and the light emitting efficiency of the LED 20 is increased.

In the automotive lamp 10 according to the embodiment, the heat pipe 40, and the heat receiving plate 41 and the heat dissipating plate 43 connected to the respective ends of the heat pipe 40, constitute a “heat transfer unit” for transferring the heat generated from the LED 20 to the heat sink 25.

It should be noted that the spirally-shaped heat pipe 40 is used in the automotive lamp 10 according to the embodiment. Where a straight heat pipe having a low flexibility is used, the movement of the lamp unit 18 is inhibited by the heat pipe as the lamp unit 18 is tilted vertically or horizontally for aiming control, with the result that it may be difficult to perform aiming control suitably. The spirally-shaped heat pipe 40 used in the embodiment is more flexible than the straight heat pipe and so can follow the movement of the lamp unit 18 during aiming control more easily than the straight heat pipe, making it possible to perform aiming control suitably.

It is preferable to form the spirally-shaped heat pipe 40 to be capable of following aiming control of about ±10° in the vertical direction and in the horizontal direction. The capability of the heat pipe 40 to follow the movement can be adjusted by changing the material forming the heat pipe 40, or the diameter or pitch of the spiral.

In the embodiment shown in FIGS. 1 through 3, the diameter of the spiral of the heat pipe 40 is constant between the LED support member 21 and the heat sink 25. However, the diameter of the spiral of the heat pipe 40 may change between the LED support member 21 and the heat sink 25.

In the embodiment shown in FIGS. 1 through 3, the pitch of the spiral of the heat pipe 40 is constant between the LED support member 21 and the heat sink 25. However, the pitch of the spiral of the heat pipe 40 may change between the LED support member 21 and the heat sink 25.

In the embodiment described above, one heat pipe 40 is provided between the LED support member 21 and the heat sink 25. Alternatively, a plurality of heat pipes 40 may be provided to increase the heat dissipating efficiency.

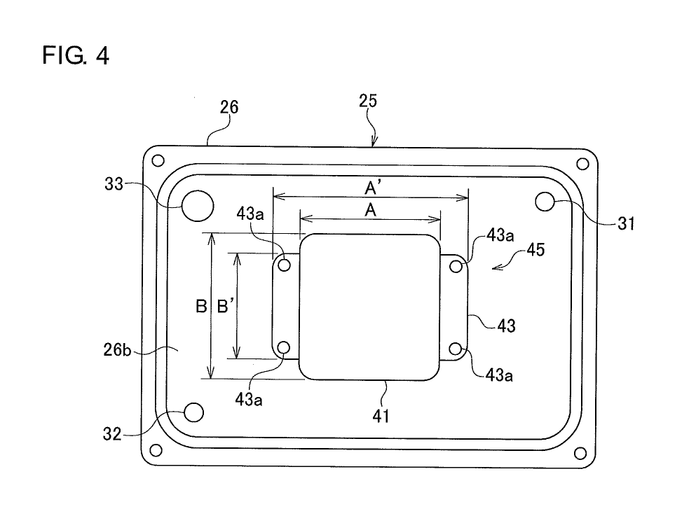

FIG. 4 is a schematic front view showing that a heat transfer unit 45 is mounted to the heat sink 25. To describe the steps of building the lamp unit 18 briefly, the heat receiving plate 41 and the heat dissipating plate 43 are first connected to the respective ends of the heat pipe 40 to assemble the heat transfer unit 45. Subsequently, the heat transfer unit 45 and the heat sink 25 are assembled by fixing the heat dissipating plate 43 to the front face 26b of the base 26 of the heat sink 25. Subsequently the heat receiving plate 41 is fixed to the rear face of the LED support member 21 on which the LED is mounted. The LED support member 21 is fitted to the first aiming screw 31, the second aiming screw 32, and the support rod 33 via the first aiming nut 34, the second aiming nut 35, and the ball joint 36. Subsequently, the projection lens 22 and the lens support 23 are mounted on the front face 21a of the LED support member 21 to complete the lamp unit 18.

The heat dissipating plate 43 includes at its corner a fixing part 43a for fixing the heat dissipating plate 43 to the base 26 of the heat sink 25. In this embodiment, a through hole is formed in the fixing part 43a and the heat dissipating plate 43 is fixed to the base 26 by a screw (not shown) inserted through the through hole.

As can be seen in FIG. 4, the fixing part 43a of the heat dissipating plate 43 is located outside the outer edge of the heat receiving plate 41, when the heat dissipating plate 43 and the heat receiving plate 41 are viewed in the direction normal to the heat dissipating plate 43. Locating the fixing part 43a of the heat dissipating plate 43 outside the outer edge of the heat receiving plate 41 facilitates tightening the screw to fix the heat dissipating plate 43 to the base 26 of the heat sink 25 and so increases the ease of assembly.

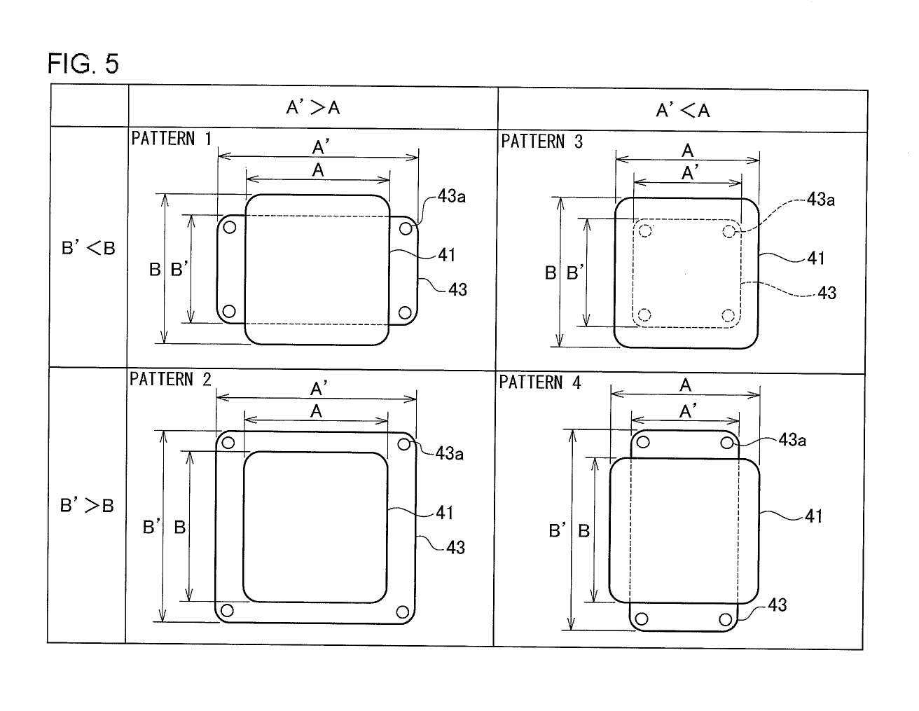

FIG. 5 shows conditions of the dimensions of the heat receiving plate 41 and the heat dissipating plate 43. It will be given here that the heat receiving plate 41 and the heat dissipating plate 43 are rectangular, the length of the horizontal side of the heat receiving plate 41 is denoted by A, the length of the vertical side of the heat receiving plate 41 is denoted by B, the length of the horizontal side of the heat dissipating plate 43 is denoted by A′, and the length of the vertical side of the heat dissipating plate 43 is denoted by B′.

FIG. 5 shows a study of four patterns determined by the relative dimensions of the heat receiving plate 41 and the heat dissipating plate 43. The four patterns are as follows.

### Pattern 1: A′>A and B′<B

### Pattern 2: A′>A and B′>B

### Pattern 3: A′<A and B′<B

### Pattern 4: A′<A and B′>B

As shown in FIG. 5, in the case of pattern 1 (A′>A and B′<B), the fixing part 43a of the heat dissipating plate 43 is located outside the outer edge of the heat receiving plate 41, when the heat dissipating plate 43 and the heat receiving plate 41 are viewed in the direction normal to the heat dissipating plate 43. In the case of pattern 2 (A′>A and B′>B), too, the fixing part 43a of the heat dissipating plate 43 is located outside the outer edge of the heat receiving plate 41, when the heat dissipating plate 43 and the heat receiving plate 41 are viewed in the direction normal to the heat dissipating plate 43. In the case of pattern 4 (A′<A and B′>B), too, the fixing part 43a of the heat dissipating plate 43 is located outside the outer edge of the heat receiving plate 41, when the heat dissipating plate 43 and the heat receiving plate 41 are viewed in the direction normal to the heat dissipating plate 43. Meanwhile, in the case of pattern 3 (A′<A and B′<B), the entirety of the heat dissipating plate 43 is located behind the heat receiving plate 41, and the fixing part 43a of the heat dissipating plate 43 is not located outside the outer edge of the heat receiving plate 41, when the heat dissipating plate 43 and the heat receiving plate 41 are viewed in the direction normal to the heat dissipating plate 43.

To summarize the above, the fixing part 43a formed at the corner of the heat dissipating plate 43 is located outside the outer edge of the heat receiving plate 41 so that the ease of assembly of the lamp unit 18 is improved, by forming the heat receiving plate 41 and the heat dissipating plate 43 to meet:

### A′>A or B′>B

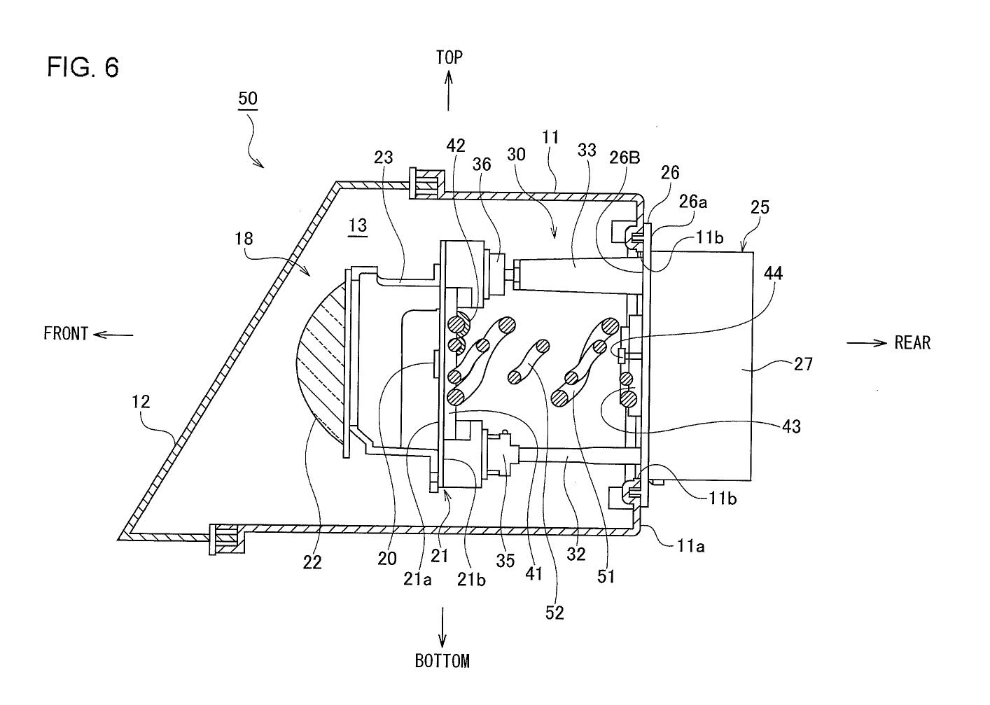

FIG. 6 shows a schematic cross section of an automotive lamp 50 according to another embodiment of the present invention. In the automotive lamp 50 shown in FIG. 6, those constituting elements that are identical to or corresponding to the elements of the automotive lamp 10 shown in FIG. 1 are denoted by the same reference numerals and associated descriptions will not be repeated as appropriate.

The automotive lamp 50 according to this embodiment differs from the automotive lamp 10 shown in FIG. 1 in that two spirally-shaped heat pipes (a first heat pipe 51 and a second heat pipe 52) are provided. The diameter of the spiral of the second heat pipe 52 is smaller than that of the first heat pipe 51. As shown in FIG. 6, the second heat pipe 52 is provided interior to the first heat pipe 51. The ends of the first heat pipe 51 and the second heat pipe 52 are connected to the heat receiving plate 41 and the heat dissipating plate 43, respectively.

By using two spirally-shaped heat pipes, the amount of heat transport is increased as compared to the case of a single heat pipe like that of the automotive lamp 10 shown in FIG. 1. Accordingly, the heat dissipating efficiency is increased. The two heat pipes may have different diameters depending on the amount of heat transport required.

In further accordance with this embodiment, the second heat pipe 52 having a smaller spiral diameter is provided interior to the first heat pipe 51 having a larger spiral diameter. As compared with the case of arranging two heat pipes, therefore, the space can be saved.

Described above is an explanation based on an exemplary embodiment. The embodiment is intended to be illustrative only and it will be obvious to those skilled in the art that various modifications to constituting elements and processes could be developed and that such modifications are also within the scope of the present invention.

Generalizing the invention embodied by the above embodiment leads to the following technical ideas.

In an automotive lamp according to one embodiment of the present invention, a lamp unit is housed in a lamp chamber, a semiconductor light emitting device being used as a light source of the lamp unit, and the lamp chamber including an outer lens and a lamp body. The automotive lamp comprises: a heat sink mounted to the lamp body such that a part of the heat sink is exposed outside the lamp chamber; a light source support member that supports the semiconductor light emitting device and that is tiltably supported relative to the heat sink; and a spirally-shaped heat pipe connecting the light source support member and the heat sink.

The heat pipe may be formed such that a diameter of a spiral may change between the light source support member and the heat sink.

The heat pipe may be formed such that a pitch of a spiral changes between the light source support member and the heat sink.

The automotive lamp may further comprise: a heat receiving plate fixed to the light source support member and connected to an end of the heat pipe; and a heat dissipating plate fixed to the heat sink and connected to the other end of the heat pipe.

The heat dissipating plate may comprise a fixing part for fixing the heat dissipating plate to the heat sink, and the fixing part may be located outside an outer edge of the heat receiving plate, when the heat dissipating plate and the heat receiving plate are viewed in a direction normal to the heat dissipating plate.

The fixing part may be provided at a corner of the heat dissipating plate, the heat receiving plate and the heat dissipating plate are rectangular, and given that a length of a horizontal side of the heat receiving plate is denoted by A, a length of a vertical side of the heat receiving plate is denoted by B, a length of a horizontal side of the heat dissipating plate is denoted by A′, and a length of a vertical side of the heat dissipating plate is denoted by B′, the heat receiving plate and the heat dissipating plate may be formed to meet:

### A′>A or B′>B.

The heat pipe may include a first heat pipe and a second heat heat pipe having a smaller diameter of a spiral than the first heat pipe, and the second heat pipe may be provided interior to the first heat pipe.

What is claimed is:

1. An automotive lamp in which a lamp unit is housed in a lamp chamber, a semiconductor light emitting device being used as a light source of the lamp unit, and the lamp chamber including an outer lens and a lamp body, the automotive lamp comprising:
a heat sink mounted to the lamp body such that a part of the heat sink is exposed outside the lamp chamber;
a light source support member that supports the semiconductor light emitting device and that is tiltably supported relative to the heat sink; and
a spirally-shaped heat pipe connecting the light source support member and the heat sink.

2. The automotive lamp according to claim 1, wherein
the heat pipe is formed such that a diameter of a spiral changes between the light source support member and the heat sink.

3. The automotive lamp according to claim 1, wherein
the heat pipe is formed such that a pitch of a spiral changes between the light source support member and the heat sink.

4. The automotive lamp according to claim 1, further comprising:
a heat receiving plate fixed to the light source support member and connected to an end of the heat pipe; and
a heat dissipating plate fixed to the heat sink and connected to the other end of the heat pipe.

5. The automotive lamp according to claim 4, wherein
the heat dissipating plate comprises a fixing part for fixing the heat dissipating plate to the heat sink, and
the fixing part is located outside an outer edge of the heat receiving plate, when the heat dissipating plate and the heat receiving plate are viewed in a direction normal to the heat dissipating plate.

6. The automotive lamp according to claim 5, wherein
the fixing part is provided at a corner of the heat dissipating plate,
the heat receiving plate and the heat dissipating plate are rectangular, and
given that a length of a horizontal side of the heat receiving plate is denoted by A, a length of a vertical side of the heat receiving plate is denoted by B, a length of a horizontal side of the heat dissipating plate is denoted by A′, and a length of a vertical side of the heat dissipating plate is denoted by B′, the heat receiving plate and the heat dissipating plate are formed to meet:
A′>A or B′>B.

7. The automotive lamp according to claim 1, wherein
the heat pipe includes a first heat pipe and a second heat heat pipe having a smaller diameter of a spiral than the first heat pipe, and
the second heat pipe is provided interior to the first heat pipe.
